(19) United States
(12) Patent Application Publication
(10) Pub. No.: US 2024/0288324 A1
(43) Pub. Date: Aug. 29, 2024

(54) PRESSURE SENSOR WITH CONTACT DETECTION OF THE DEFLECTION OF THE MEMBRANE, PRESSURE SENSOR SYSTEM AND METHOD FOR GENERATING A PRESSURE SIGNAL

(71) Applicant: Robert Bosch GmbH, Stuttgart (DE)

(72) Inventors: Joachim Kreutzer, Stuttgart (DE); Arne Dannenberg, Metzingen (DE); David Slogsnat, Tuebingen (DE)

(21) Appl. No.: 18/572,026

(22) PCT Filed: Jun. 2, 2022
(86) PCT No.: PCT/EP2022/065093

§ 371 Date: Dec. 19, 2023

(30) Foreign Application Priority Data
Jul. 20, 2021 (DE) 10 2021 207 736.6

(51) Int. Cl. G01L 9/00; G01L 13/02

(52) U.S. Cl. CPC G01L 9/0047; G01L 9/0072; G01L 13/025

(57) ABSTRACT

A micromechanical pressure sensor element as well as a pressure sensing system comprising such a pressure sensor element, with which the pressure sensor element establishes an electrical contact in the event of a specified first pressure being applied. The pressure sensor element has a membrane that can be moved or deflected by an applied pressure. A first cavity into which the membrane can be deflected is provided below the membrane. Two contact elements are provided which come into contact with each other, in particular via a mechanical contact, on the basis of a first applied pressure being exceeded so that an electric contact is established. At least one first contact element, which is directly or indirectly connected to the membrane, and a second contact element, which is directly or indirectly connected to the cavity bottom, are provided.

### FIELD

The present invention relates to a pressure sensor element that has a contact detection of the deflection of the membrane resulting from an applied pressure, along with a pressure sensor system with such a pressure sensor element and a method for generating a pressure sensor signal with such a pressure sensor element.

### BACKGROUND INFORMATION

A typical micromechanical pressure sensor usually has a membrane that is bent by the applied pressure. This pressure-dependent bending of the membrane can be captured by piezo elements attached to or on the membrane. Alternatively, the movement of the membrane can also be captured by a capacitor arrangement in which a movable electrode is attached to the membrane and a fixed or non-movable counter-electrode is attached to the housing or the carrier of the pressure sensor element. The pressure-dependent sensor signal can be derived from the change in capacitance between the two electrodes.

In general, there is a risk that the membrane will be bent too far, so that damage to the membrane can ensue. In addition, the bending of the membrane only represents a linear dependency on the applied pressure in certain deflection ranges, in particular if part of the membrane rests on the bottom of the associated cavity. The sensor signal must thus be adjusted accordingly outside a certain pressure range in order to capture the actual applied pressure. In the case of capacitive pressure sensors, the electrodes can also be damaged if they come into contact with each other, particularly as a result of a short, strong pressure surge.

A micromechanical pressure sensor is described in German Patent Application No. DE 10 2010 040 373 A1, with which stop elements on a counter-element allow the membrane to be placed in a targeted manner when there is sufficient bending. Furthermore, a resilient suspension of the counter-element acting as a damping element makes possible a two-stage capture of the pressure with different characteristic curves or pressure dependencies of the membrane movement.

The present invention is intended to describe a pressure sensor that detects the approach of the membrane to a stop, in order to facilitate the evaluation of the pressure sensor signal.

### SUMMARY

The present invention relates to a micromechanical pressure sensor element as well as a pressure sensing system comprising such a pressure sensor element, with which the pressure sensor element establishes an electrical contact in the event of a specified first pressure being applied. For this purpose, according to an example embodiment of the present invention, the pressure sensor element has a membrane that can be moved or deflected by an applied pressure. A first cavity into which the membrane can be deflected is provided below the membrane. The present invention is characterized in that two contact elements are provided which come into contact with each other, in particular via a mechanical contact, on the basis of the first applied pressure being exceeded so that an electric contact is established. At least one first contact element, which is directly or indirectly connected to the membrane, and a second contact element, which is directly or indirectly connected to the cavity bottom, are provided.

An advantage of such a configuration is that the distance of the membrane from the stop on the cavity bottom can be captured by a suitable attachment of the two contact elements. For example, a corresponding positioning and configuration of the two contact elements can be provided, with which the electrical contact is established before the membrane is deflected to such an extent that it is set down on the cavity bottom.

According to an example embodiment of the present invention, the distance between the membrane and the cavity bottom can be set, for example, by using and dimensioning at least one spacer element. Such a spacer element can be attached directly or indirectly to the membrane, for example. If the membrane is deflected by an applied pressure, the spacer element will also move with the deflection of the membrane in the direction of the cavity bottom until it sets down. By attaching the first contact element to the lower end of the spacer element and providing the second contact element in the region of the set-down point on the cavity bottom, the establishment of an electrical contact is achieved through a set-down.

In an alternative configuration, according to an example embodiment of the present invention, at least one spacer element is attached to the cavity bottom, at the end of which, pointing toward the membrane, the second contact element is attached. By attaching the first contact element to the membrane, which is brought onto the second contact element when the membrane is deflected, an establishment of contact can also be achieved with this configuration. This configuration has the advantage that a smaller mass has to be moved with the membrane.

The pressure sensor element according to an example embodiment of the present invention can have not only a capture of the deflection by means of piezo elements on or in the membrane but also a capture by means of a capacitive sensor evaluation. When using a capacitive evaluation, it is provided that the membrane directly or indirectly comprises a first electrode. The first electrode can be integrated directly into the membrane or arranged at the lower end in the form of a suspension, for example as an anvil. The latter has the advantage that a flat first electrode can be produced, which can be moved parallel to the flexure of the membrane onto a second electrode provided on or in the cavity bottom. Together, the first and second electrodes thus form a first measuring capacitor, which changes on the basis of the pressure applied to the membrane and thus the distance between the two electrodes.

According to an example embodiment of the present invention, when using electrodes to capture the measured value of the pressure sensor element, it can be provided that the at least first contact element is attached laterally to the first electrode and the at least second contact element is attached laterally to the second electrode. Since not only the electrodes but also the contact elements are intended to supply electrical signals, it is important to ensure that at least one of the electrodes is electrically insulated from the contact elements.

By using the contact elements and their mechanical and electrical contact when the first pressure variable is reached, a two-stage pressure capture can also be realized. For example, it can be provided that when the first contact element is set down on the second contact element, the membrane will not yet be touching the cavity bottom below, but instead there is still sufficient distance for further deflection of the membrane. Accordingly, with a capacitive measuring principle, it can be provided that the two electrodes, including any insulating layer that may be present, do not yet touch each other. In this case, the pressure sensor element can be provided in such a way that the effective membrane surface on which the applied pressure acts to deflect the membrane is only reduced by the set-down of the contact elements. It is thus provided that if the pressure continues to increase, the membrane is deflected further and thus a further pressure-dependent signal can be generated until the membrane is finally set down on the cavity bottom or the two electrodes come into mechanical contact. Alternatively, a stop can also be provided, in order to protect the membrane from damage. However, due to the reduced membrane surface, a changed pressure dependency must be taken into account above the first pressure variable. With the corresponding sensor evaluation, this transition can be recognized on the basis of the establishment of contact generated.

The advantage of such a configuration is that the detection of two different and, in particular, adjacent pressure ranges can be realized, in particular without any gaps, using a pressure sensor element. A higher resolution can be realized in a first pressure range up to the first pressure, wherein a more robust configuration is present in the second, higher pressure range. Short-term pressure peaks above a preferred pressure range can thus be captured and evaluated without jeopardizing the function of the pressure sensor element.

In addition, according to an example embodiment of the present invention, a configuration is provided in which a second micromechanical pressure sensor element is used in addition to a first micromechanical pressure sensor element according to the present invention. The second micromechanical pressure sensor element has the same or at least a similar structure. This means that the second micromechanical pressure sensor element also has a membrane that can be moved by an applied pressure, in particular in the direction of a cavity located under the membrane. This second pressure sensor element also has two contact elements, which are attached directly or indirectly to the membrane as well as to or on the cavity bottom.

An advantage of such a configuration by means of at least two pressure sensor elements, which are wired as a full Wheatstone bridge, for example, is that the dimensions of the pressure sensor elements and the conditions that lead to mechanical and/or electrical contact of the respective contact surfaces can be designed differently. For example, the second pressure sensor element can also have a third spacer element, which is arranged directly or indirectly on the second membrane. The third contact element provided can be arranged at the end of the third spacer element directed towards the cavity bottom in such a way that, in the event of bending, it meets a fourth contact element, which is attached to the cavity bottom, in order to establish the electrical contact. Alternatively, of course, a fourth spacer element can also be provided, which is attached to the cavity bottom and has the fourth contact element at its end directed toward the membrane. In this case, the third contact element is provided on the membrane.

The two pressure sensor elements can have the same or a different pressure capture principle. If a capacitive measuring principle is used for the second pressure sensor element as well, a third electrode, possibly with an assigned third contact element, can also be provided. Accordingly, a fourth electrode can be provided on the cavity bottom, possibly with a fourth contact element. In this case as well, it is important to ensure that the electrodes and the contact elements are electrically insulated from each other.

As already mentioned, the two pressure sensor elements can differ from each other due to their differently dimensioned structure. For example, the spacer elements of both pressure sensor elements can differ in their substantially vertical dimensions, while the rest of the structure, for example the membrane surface and the distance of the membrane or the electrode from the cavity bottom, is otherwise the same. This allows the contact surfaces assigned to one of the membranes to meet even before the contact surfaces of the other membrane and thus form an electrical contact. This allows the distances between the electrodes, for example, to be designed differently, in order to realize a larger spread or a plurality of pressure range captures. In addition, it can also be provided that the stiffnesses, i.e., the mobility of both membranes, differ, so that different pressure dependencies can also be realized by such a configuration, in particular to realize overlapping pressure sensor regions.

Furthermore, according to an example embodiment of the present invention, a method for generating a pressure sensor signal is provided for the at least one pressure sensor element or the pressure sensor system according to the present invention. This exploits the fact that the movement of the membrane up to a first pressure does not generate any electrical contact between the first contact element connected to the membrane and the second contact element. Thus, in a first operating mode, the method can derive, determine or generate the pressure sensor signal on the basis of the movement of the membrane. Upon detection and/or presence of an electrical contact between the first and second contact elements, the method can further derive, determine or generate the pressure sensor signal on the basis of the pressure-dependent movement of the membrane. However, since this movement of the membrane shows a different pressure dependency due to the reduced area of application of the pressure on the membrane, the pressure sensor signal in the second operating mode is derived, determined or generated with a different weighting factor or parameter than in the first operating mode.

In one configuration of the present invention, further operating modes can be provided on the basis of the presence or detection of further electrical contacts of further contact elements. These can be, for example, the electrical contacts of contact elements that are present in a second pressure sensor element.

In general, it can be provided that at least two of the operating modes used generate the pressure sensor signal on the basis of the pressure-dependent movement of two different pressure sensor elements. It can thus be provided that, in the second operating mode, the pressure-dependent movement of a second membrane in a second pressure sensor element is used to generate the pressure sensor signal.

Further advantages can be seen from the following description of exemplary embodiments and the rest of the disclosure herein.

### BRIEF DESCRIPTION OF THE DRAWINGS

FIGS. 1 and 2 show the mode of operation in principle using the example of a capacitive pressure sensor including two pressure sensor elements, according to the present invention.

FIGS. 3A to 3C show the use of different stiffnesses in the bending of the membrane, by means of which two different pressure ranges can be realized.

FIGS. 4A and 4B show an alternative to capturing the distance by means of a spacer element, according to an example embodiment of the present invention.

FIGS. 5A and 5B show the alternative expanded to realize the capture of different pressure ranges, according to an example embodiment of the present invention.

FIG. 6 schematically shows an evaluation unit for the pressure sensor element or the pressure sensor system, according to an example embodiment of the present invention.

FIG. 7 shows an example of a connection of the measuring capacitors of the pressure sensor according to the present invention in the form of a Wheatstone bridge circuit.

### DETAILED DESCRIPTION OF EXAMPLE EMBODIMENTS

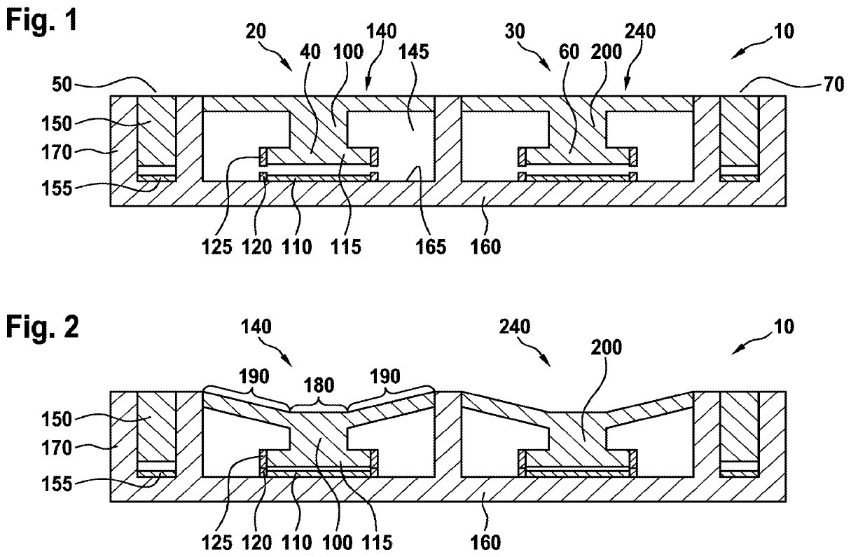

In FIGS. 1 and 2, a first embodiment of the present invention is described with reference to a pressure sensor system 10 consisting of a first micromechanical pressure sensor element 20 and a second micromechanical pressure sensor element 30. The two pressure sensor elements are identical in this design, so that their behavior when pressure is applied is identical. To simplify matters, the function of the configuration according to the present invention is therefore only described for one pressure sensor element. The use of two identical pressure sensor elements in particular has the advantage that the measuring signal can be amplified, for example in the form of an interconnection based on a Wheatstone bridge circuit.

The first micromechanical pressure sensor element 20 has a membrane 140 that spans a cavity 145. The membrane, the cavity and also the further elements or components of the pressure sensor element, which are still to be described, can be manufactured using conventional micromechanical methods, such as etching methods, the use of sacrificial layers, epitaxy, trench etching methods or bonding processes. A fastening 100 or stiffening of the membrane 140 is provided on the underside of the membrane, for example in the form of a boss membrane, at the lower end of which a first electrode 115 is arranged, which is directed in the direction of a second electrode 110 attached to the bottom 165 of the cavity 145. Together, the first and second electrodes 115 and 110 form the first measuring capacitor 40. In a force-free state, i.e. without a pressure of a medium being applied to the membrane 140, a distance between the first and second electrodes can be set by a corresponding design. This distance, which is reduced by the applied pressure and thus generates a capacitance change in the electrodes 110 and 115, can be used as the first measuring capacitor of the first pressure sensor element 20 for deriving a pressure sensor signal. A reference capacitor 50 consisting of a rigid and non-movable upper electrode 150 and a lower, likewise rigid electrode 155 in a common housing 170 or a carrier substrate can be assigned to the pressure sensor element 20 as a reference.

According to the present invention, the first exemplary embodiment shown in FIG. 1 has two contact elements that touch each other upon a corresponding movement or bending of the membrane 140 and thus generate the establishment of an electrical contact. In the first exemplary embodiment, a first contact element 125 is assigned to the side of the first electrode 115 and a second contact element 120 is assigned to the side of the second electrode 110. Since not only the electrodes 110, 115 but also the contact elements 120, 125 can have electrically at least partially conductive regions, it is provided that the relevant electrode is electrically insulated from the laterally attached contact element. Furthermore, it can be provided that at least one of the two electrodes has an insulating layer, so that a short circuit does not occur even if both electrodes come into direct mechanical contact. Optionally, it can also be provided that, in each case, a contact element is not provided on both sides of the electrodes, but only on one side.

FIG. 2 shows the effect of a pressure of the medium to be captured applied to the membrane 140. If the pressure of the medium reaches a first pressure value or a first pressure variable, the first contact element 125 is pressed onto the second contact element 120 below it, so that an electrical contact is established. This electrical contact can be used to recognize a sufficient deflection of the membrane 140 from its rest position, to detect a defined distance between the two electrodes or to detect a transition from one capture region of the pressure sensor element to another. As can be seen from FIG. 2, the bending of the entire membrane 140 is effected substantially in a region 190 to the side of the suspension 180 of the fastening 100. This bending of the lateral suspension substantially represents the pressure dependency of the membrane 140, which can be captured by the changed measuring capacitor of the first and second electrodes. If, when the first pressure is reached at the membrane 140, there is still a distance between the two electrodes, in particular a preset distance, the first electrode 115 can be pressed further in the direction of the lower electrode 110 by a higher pressure applied to the membrane, so that a further measuring signal that has a different pressure dependency can be captured. Only when a higher second pressure is reached is a mechanical set-down of the first electrode on the second electrode effected, so that further movement of the membrane is prevented.

It should also be mentioned that a set-down of the two electrodes can lead to a short circuit of one measuring capacitor, wherein the output voltage of the evaluation bridge is approximately half the supply voltage and a short circuit of the second measuring capacitor leads to an output voltage of the full bridge capacitor. Such behavior can also be used-without further connections on the MEMS—as an interrupt for the evaluation circuit. In power-saving mode, the bridge of the MEMS can be supplied with voltage without high current consumption, since it is purely capacitive and therefore has no relevant leakage current.

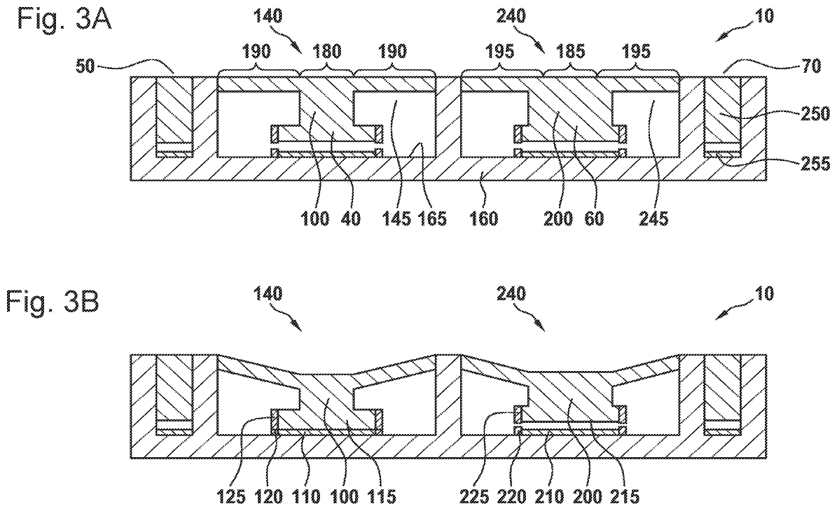

In a second exemplary embodiment of the present invention in accordance with FIG. 3A, a changed stiffness of the second membrane 240 of the second pressure sensor element 30 can be used to capture pressures in different pressure ranges with the pressure sensor system 10. For this purpose, the otherwise identical membrane surface of the first and second membranes 140 and 240 is subdivided differently. To increase the stiffness of the bending of the second membrane 240, the corresponding suspension 185 for the fastening 200 of the second measuring capacitor 60, consisting of a third electrode 215 and a fourth electrode 210, has a wider lateral configuration than the comparable suspension 180. This wide suspension 185 results in a shortening of the lateral regions 195 with an otherwise equally large membrane surface, which is substantially responsible for the bending of the second membrane 240. In addition, as with the first pressure sensor element 20, the second measuring capacitor 60 can have a reference capacitor 70 with a rigid and non-movable upper electrode 250 and a lower, also rigid electrode 255 in the common housing 170.

If pressure is now applied to the pressure sensor system 10 in FIG. 3A, the membranes 140 and 240 will be bent differently due to the different stiffnesses. While contact is already established between the first and second contact elements 125 and 120 at a first pressure, the contact elements 225 and 220 of the second pressure sensor element 30 are still spaced apart (see FIG. 3B). Only when a higher third pressure is present is the membrane 240 bent to such an extent that the third contact element is set down on the fourth contact element 225 and 220 and establishes electrical contact (FIG. 3C). A pressure measurement can thus be carried out in a first pressure range up to the first pressure (value) with both the first and the second pressure sensor elements. However, if the applied pressure exceeds this first pressure (value), the subsequent measurement up to the third pressure (value) is effected exclusively via the second pressure sensor element with the second measuring capacitor 60. Optionally, as in the first exemplary embodiment, a distance can also be provided between the electrodes at set-down of the contact elements. In this case, the first measuring capacitor 40 would make a small contribution due to the smaller membrane surface in the region 180 compared to the total membrane surface of the membrane 240.

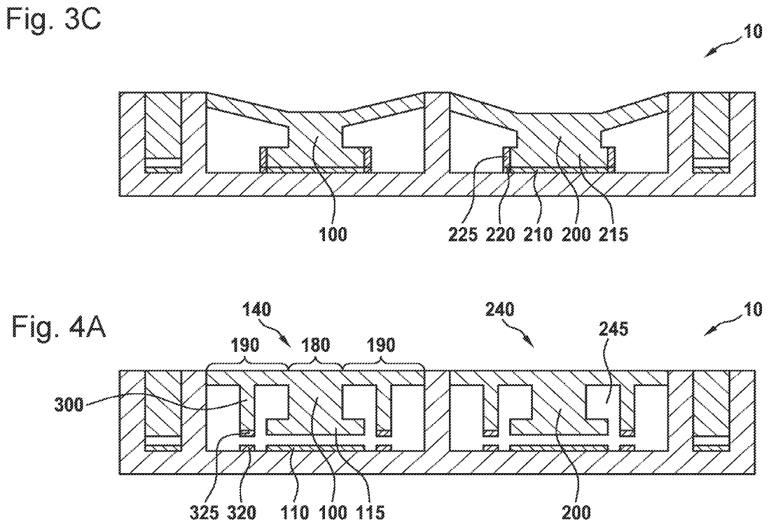

Optionally, the contact elements can also be attached away from the electrodes. In this regard, a third exemplary embodiment is shown in FIG. 4A. The first measuring capacitor with the electrodes 110 and 115 is again substantially attached in the center of the membrane 140. However, the first and second contact elements 325 and 320 are not arranged on the electrodes, but on separate spacer elements 300. These spacer elements 300 can be arranged on the membrane 140 as shown in FIG. 4A and lead in the direction of the cavity bottom 165. The first contact element 325 can be provided at the lower end of the spacer element 300 and the second contact element 320 can be provided at the bottom of the cavity 165. Alternatively, at least one of the spacer elements can also be attached to the cavity bottom 165, which element is then oriented vertically in the direction of the membrane 140. The second contact element can be arranged at the upper end of the spacer element and the first contact element at the membrane 140. This configuration has the advantage that the membrane 140 as such neither has an influence on the stiffness in the lateral region 190 nor has to move an additional mass.

With the aid of FIG. 4B, the deflection of such a membrane 140 provided with spacer elements 300 is illustrated. In order to enable a clear and uniform deflection of the membrane 140, it is preferably provided that the spacer elements 300 have a uniform spacing on both sides of the fastening 100. A central arrangement, which also helps to define the diameter after placement, in particular with regard to pressure sensitivity in the second pressure range, is particularly useful here. Accordingly, the spacer elements used there are also attached to the second pressure sensor element. When the first pressure is present, a set-down of the first contact element on the second contact element and thus the establishment of electrical contact are effected. As already explained for the previous exemplary embodiment, it can be provided that the electrodes 110 and 115 are still spaced apart from each other at set-down of the contact elements. However, this configuration is not mandatory, but prevents mechanical damage to the electrodes or to an applied insulating layer and enables the use of a wider pressure range.

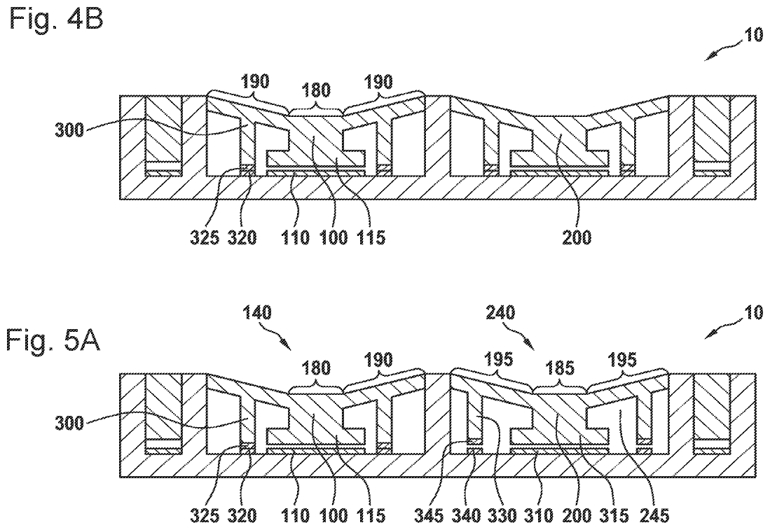

By varying the length of the spacer elements or even the stiffness of the membranes 140 and 240, different pressure ranges can also be captured by the two measuring capacitors in this example. FIGS. 5A and 5B show another way of designing the capture regions of the two pressure sensor elements differently. The spacer elements 300 of the first pressure sensor element and the spacer elements 330 of the second pressure sensor element are not arranged at the same location in the lateral region 190 of the membrane 140, for example by being provided at different distances from the fastening 100 or 200 or from the edge of the membrane enclosure. Instead, the spacer elements 330 are attached, for example, at a greater distance from the central suspension region 185 in the lateral region 195 with otherwise identical (vertical) dimensions. As can be seen from FIG. 5A, contacting of the first two contact elements of the first pressure sensor element 20 is effected at a first pressure (value) of the medium applied to the membranes. At this pressure, however, the membrane 240 of the second pressure sensor element 300 is not yet bent to such an extent that the spacer elements 330 arranged further out do not yet make contact with the third and fourth contact elements 345 and 340. Only at a higher third pressure is their contacting also effected (see FIG. 5B). Alternatively, it can also be provided in this embodiment that at least one of the measuring capacitors still has a sufficient distance between the electrodes even at a higher pressure than the third pressure (value).

In general, the present configuration of the present invention can also be used when piezo resistors are used to capture the bending on or in the membrane. For this purpose, the aforementioned spacer elements are to be substantially attached to the membrane and/or to the cavity bottom.

In all designs, the contact elements can also be designed as piezo elements that emit an electrical impulse when mechanically set down. It can be provided that only one side of the contact element is designed as a piezo element and the other side is designed in such a way that it promotes the generation of the piezo effect.

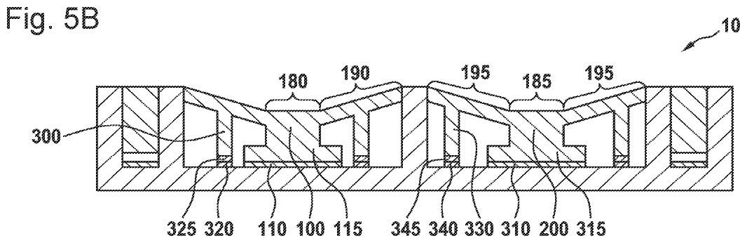

As already explained above, the present invention can be used to realize different pressure ranges with different pressure dependencies. The transition from one pressure range to another can be detected by capturing the establishment of electrical contact. However, it is also possible to evaluate the behavior of the first and second measuring capacitors, in order to detect the transition. A corresponding evaluation unit 400, which carries out an evaluation method, is shown in FIG. 6.

The evaluation unit 400 has a memory 410 in which the captured measuring capacitors, electrical contacts and also the derived pressure variables can be stored. The corresponding measured values are read in by the first measuring capacitor 420 or 40 and/or by the second measuring capacitor 430 or 60. The measured values of the reference capacitors 50 and 70 can also be read in to capture reference values. To capture the transition from one pressure range to the other, the establishment of electrical contacts of the first and second contact elements 440 and/or of the third and fourth contact elements 450 is captured. The establishment of electrical contacts captured in this way can be used in the evaluation unit 400 to switch the evaluation from one pressure dependency to another. Depending on the configuration of the at least one pressure sensor element 20 or the interaction with at least one second pressure sensor element 30, a transition, with which a pressure value can be detected by means of both the first and the second measuring capacitors, can also be captured. In this case, the second measured value capture can be used to check the captured pressure value. As already described, the derived pressure variable or the pressure value can be stored in a memory 420 for a corresponding query or for further processing. In addition, however, direct forwarding to a further system 460, for example a pressure-dependent control system, is also possible. In addition or as an alternative, a display 470 of the pressure is also possible.

The mode of operation of the generation of a pressure sensor signal can be illustrated by the connection of the measuring capacitors of the pressure sensor according to the present invention by means of a Wheatstone bridge circuit. In each case, one measuring capacitor and one reference capacitor of a pressure sensor element form a half-bridge. The supply of such Wheatstone bridge circuit is effected via a supply voltage 500. The tapping of the pressure sensor signal is effected via a center tap 510.

In the example in FIG. 1, the two measuring capacitors 40 and 60 would generate a pressure sensor signal at the center tap 510 on the basis of the bending of the entire membrane 140 or 240 until the first pressure is reached, that is, until the set-down of the contact elements 320 and 325. After the first pressure is exceeded, the approach of the first electrode 115 to the second electrode 110 of the first measuring capacitor 40 would be effected on the basis of the bending of only a part 180 of the total membrane 140. Since this partial region 180 has a smaller surface area than the overall membrane, a different pressure dependency is output at the center tap 510. By detecting the set-down of the contact elements 120 and 125, this changed pressure dependency can be taken into account, in particular with knowledge of the geometries of the partial region surface 180 in relation to the total membrane surface, during the evaluation or derivation and further processing of the pressure sensor signal at the tap 510. It is possible, for example, to link the detection of the set-down to a switchover of the pressure range. Interrupts, a switchover of the linearization/compensation functions or the use of different (weighting) parameters can also be used here.

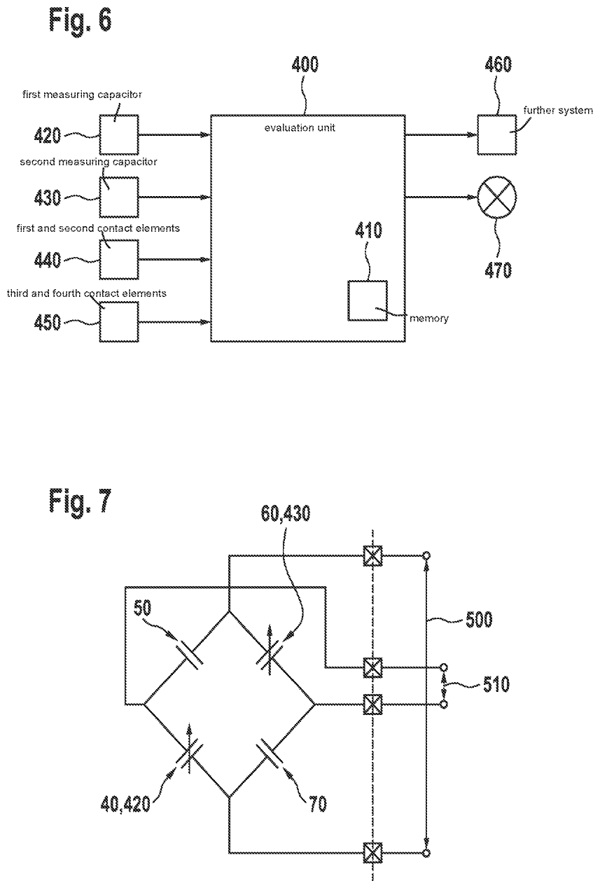

An embodiment with two differently designed pressure sensor elements 20 and 30, as shown in FIGS. 3A-3C, 4A, 4B, 5A, and 5B, can also be evaluated with a bridge circuit in accordance with FIG. 7. Thus, a structure of a pressure sensor in accordance with FIGS. 3A to 3C with two pressure ranges, with which the pressure is captured in a first pressure range up to a first pressure with both measuring capacitors 40 and 60, can be realized. However, once the contact elements 120 and 125 and, in particular, the first electrode 115 have set down on the second electrode 110, the first measuring capacitor 40 will no longer make any further contribution to the derivation of the pressure sensor signal. Instead, above the first pressure, the second measuring capacitor 60 with its stiffer membrane 240, which can be bent by a higher applied pressure, forms the basis for the derivation of the pressure sensor signal at the tap 510. When an even higher third pressure is reached, the third then also sets down on the fourth contact element 225 or 220, in particular while the third electrode 225 sets down simultaneously on the fourth electrode 220, as a result of which the second measuring capacitor 60 can no longer make a contribution to the pressure sensor signal. Optionally, it can be provided that there is still a distance between the associated electrodes of the measuring capacitor at set-down of the corresponding contact elements. In this case, further pressure ranges can be defined, since the reduction in the distance between the electrodes can still be measured due to the higher pressures applied.

Instead of just two different pressure ranges, in each case with its own pressure dependency, different, in particular adjacent, pressure ranges for pressure signal capture can also be realized with the structures in FIGS. 4A, 4B, 5A, and 5B. Contact elements 320 and 325, which are not arranged directly on the first measuring capacitor 40, but are assigned thereto, along with corresponding contact elements 340 and 345 of the second measuring capacitor 60 take over the transition points of the pressure ranges described in the above exemplary embodiments. By the design of the length as well as of the position of the punches 300 and 330 in the lateral region 190 and 195 of the corresponding membranes 140 and 240, specific pressure dependencies can be set. If one of the contact elements is placed on its counterpart when pressure is applied, this can be recognized both from the resulting pressure sensor signal at the tap 510 and via an electrical connection between the contact elements. As explained above, the electrical contacts captured in this way can be used for the evaluation, in order to switch from a pressure evaluation with a first pressure dependency to another pressure evaluation with a pressure dependency different from the first pressure dependency. Accordingly, a plurality of pressure dependencies can be defined in different pressure ranges if a plurality of electrical contacts are present.

A method for generating a pressure sensor signal can also be described using the designs described above in accordance with the circuitry of the at least one pressure sensor element. The pressure sensor signal is derived based on the detected pressure-dependent movement of at least one membrane. In addition, the method can detect the electrical contacting of two assigned contact elements, in order to derive the different pressure ranges. The various pressure dependencies of the membrane movements can be taken into account in the derivation, for example by using larger or smaller weighting factors or parameters. For example, the output can be normalized or displayed continuously. A switchover of the linearization or compensation function for the different pressure ranges on the basis of the detected contacting of the respective contact elements is also possible.

1-13. (canceled)

14. A micromechanical pressure sensor element for capturing a pressure sensor signal, using capacitive pressure capture, comprising:
a first membrane movable based on an applied pressure;
a first cavity located below the first membrane with a cavity bottom, wherein a pressure of a medium applied to the first membrane bends the first membrane in a direction of the cavity bottom;
at least one first contact element which is directly or indirectly connected to the first membrane; and
at least one second contact element which is directly or indirectly connected to the cavity bottom;
wherein an establishment of an electrical contact between the first and the second contact element is effected based on a specified first pressure being applied to the first membrane.

15. The micromechanical pressure sensor element according to claim 14, further comprising:
a first spacer element which is connected directly or indirectly to the first membrane, wherein the first contact element is arranged on the first spacer element, on a side of the first spacer element facing away from the first membrane.

16. The micromechanical pressure sensor element according to claim 14, further comprising:
a second spacer element which is connected to the cavity bottom, wherein the second contact element is arranged on the second spacer element, on a side of the second spacer element facing away from the cavity bottom.

17. The micromechanical pressure sensor element according to claim 14, wherein the pressure capture is effected using a capture of a capacitance change of two electrodes, wherein a first electrode of the two electrodes is provided directly or indirectly on the first membrane, and a second electrode of the two electrodes is provided on the cavity bottom, wherein the first contact element is arranged laterally on the first electrode and/or the second contact element is arranged laterally on the second electrode.

18. The micromechanical pressure sensor element according to claim 14, wherein the first membrane has at least two different pressure-dependent movements, wherein the first membrane has a first pressure dependency in a first pressure range until the first pressure is reached, and a second pressure dependency above the first pressure in a second pressure range, wherein the second pressure dependency is present until a second pressure applied to the first membrane is reached.

19. A pressure sensor system, comprising:
at least one micromechanical pressure sensor element for capturing a pressure sensor signal, using capacitive pressure capture, including:
a first membrane movable based on an applied pressure,
a first cavity located below the first membrane with a cavity bottom, wherein a pressure of a medium applied to the first membrane bends the first membrane in a direction of the cavity bottom,
at least one first contact element which is directly or indirectly connected to the first membrane, and
at least one second contact element which is directly or indirectly connected to the cavity bottom,
wherein an establishment of an electrical contact between the first and the second contact element is effected based on a specified first pressure being applied to the first membrane; and
a second micromechanical pressure sensor element, including:
a second membrane movable based on an applied pressure,
a second cavity located below the second membrane, with a cavity bottom, wherein a pressure of a medium applied to the second membrane bends the second membrane in a direction of the cavity bottom of the second cavity, and the second micromechanical pressure sensor element,
at least one third contact element which is directly or indirectly connected to the second membrane, and
a fourth contact element which is directly or indirectly connected to the cavity bottom of the second cavity,
wherein electrical contact is made between the third and fourth contact elements based on a specified third pressure applied to the membrane.

20. The pressure sensor system according to claim 19, wherein the second micromechanical pressure sensor element has a third spacer element, which is connected directly or indirectly to the second membrane, wherein the third contact element is arranged on the first spacer element, on a side of the first spacer element facing away from the first membrane.

21. The pressure sensor system according to claim 19, wherein a pressure detection of the second micromechanical pressure sensor element is effected by detection of a capacitance change of two electrodes, wherein a third electrode of the two electrodes is provided directly or indirectly on the second membrane and a fourth electrode of the two electrodes is provided on the cavity bottom of the second cavity, wherein the third contact element is arranged laterally on the third electrode and/or the fourth contact element is arranged laterally on the fourth electrode.

22. The pressure sensor system according to claim 19, wherein the first and the third pressures are different.

23. The pressure sensor system according to claim 19, wherein pressure-dependent movements of the first and second membranes are different in at least one pressure range.

24. A method for generating a pressure sensor signal using at least one pressure sensor element or a pressure sensor system including the at least one pressure sensor element, wherein the pressure sensor element includes:
at least one movable membrane which exhibits a movement based on a pressure;
at least one first contact element which is directly or indirectly connected to the movable membrane; and
at least one second contact element which establishes an electrical contact with the first contact element upon a predetermined movement of the membrane;
wherein the method includes at least two operating modes, the method comprising:
in a first operating mode, generating the pressure sensor signal based on a first pressure-dependent movement of the at least one membrane; and
in a second operating mode, generating the pressure sensor signal based on a detected electrical contact and a second pressure-dependent movement of the at least one membrane.

25. The method according to claim 24, wherein the method has at least one further operating mode, with which the pressure sensor signal is generated in addition to the pressure-dependent movement of the at least one membrane based on a further electrical contact of further contact elements.

26. The method according to claim 24, wherein the pressure signal is generated in at least two operating modes based on pressure-dependent movements of two different membranes.
